(19) United States
(12) Patent Application Publication
(10) Pub. No.: US 2014/0266662 A1
(43) Pub. Date: Sep. 18, 2014

(54) Portable Baby Car Seat Occupancy Alarm Device

(71) Applicant: Kelvin Matos, Coamo, PR (US)

(72) Inventor: Kelvin Matos, Coamo, PR (US)

(21) Appl. No.: 14/209,475

(22) Filed: Mar. 13, 2014

Related U.S. Application Data
(60) Provisional application No. 61/799,820, filed on Mar. 15, 2013.

(51) Int. Cl. G08B 21/02

(52) U.S. Cl. CPC G08B 21/0288
USPC 340/457

(57) ABSTRACT

A portable child car seat alarm system for notifying a driver, parent or guardian when a child is left unattended in the child safety car seat. The portable security device includes an alarm module, a weight sensor and a 12-volt adapter. The system detects if a child is in the car seat via the weight sensor. The portable security device, connected to the vehicle's electrical system via the 12-volt adapter, detects when the ignition of the vehicle is turned off. The alarm module is activated when the ignition of the vehicle is turned off. Should a child remain in the seat when the driver's turns off the ignition, the alarm system notifies the driver that a child is sitting in the safety seat. The invention is small enough to be installed under any generally available child safety car seat and permits ease of portability from one car to another.

### RELATED APPLICATIONS

This application claims the benefit of U.S. Provisional Application No. 61/799,820 filed Mar. 15, 2013, which is hereby incorporated by reference in its entirety

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISK APPENDIX

N/A

### BACKGROUND

1. Field of Invention

The present invention is in the field of transportation safety devices intended to be used for child transportation inside automobiles and detection of unattended children within a vehicle. Specifically, the invention is an alarm system used in conjunction with a children's safety car seat to alert when a child has been left inside a vehicle after the vehicle's ignition is turned off.

2. Description of Prior Art

There has been a recent increase in news headlines of children inadvertently being left inside vehicles by parents or guardians. This has led to a discussion of the potential danger to the children and the criminal and legal implications on the parents.

There are a number of inventions that provide a generic means for notifying a person that a child is left in a vehicle. The means of monitoring as well as the means for notification are limited as addressed herein. Moreover, none of the prior art listed below is portable. However, the number of cars per household is increasing. This has established a need for a portable alarm system that can be moved with ease from one car to another.

Smith (U.S. Pat. No. 6,489,889) claims an occupant sensing system, utilizing the seat belt to indicate if the seat is occupied.

Burgess (U.S. Pat. No. 6,812,844) claims a child alert device, which monitors when a door is opened via sensing the change in air pressure within a vehicle. Warning to the parent or guardian is via light and sound.

Kalce (U.S. Pat. No. 6,998,988) claims an infant alarm system for an automobile, wherein said system is activated by a pressure sensitive pad placed onto the driver's seat.

Monzo et al. (U.S. Pat. No. 7,348,889) claim a system and method to warn that a child has been left unattended in the vehicle for a pre-set period of time after the ignition has been turned off.

Morningstar (U.S. Pat. No. 8,063,788) claims another warning system for recognizing a child in a child safety seat by either a pressure pad or a secured seat lap belt. The system is activated by the release of the driver's seat belt.

Schoenberg and Steffan (Pub. No.: US 2012/0242476) claim an alarm system, utilizing a pressure device on the car seat to indicate occupancy of a child coupled to an accelerometer for detecting car movement. If the accelerometer detects car movement but the pressure device does not detect a child's weight a notification system is activated to alert the driver that the child has left the car seat.

### SUMMARY OF THE INVENTION

The present invention is a portable security device to be installed in any automobile with a 12-volt power source. The system includes a weight sensor and an alarm module to be installed under any generally available child safety car seat. The invention is intended to notify a driver, parent or guardian, in the event that an infant is left unattended in its safety car seat after the vehicle's ignition has been turned off. The alarm will notify the driver, parent or guardian after a predetermined time has elapsed from the moment the ignition is tuned off.

The defining characteristics of the present invention are its portability, simplicity and adaptability. The simplicity of the electronic design allows small and lightweight construction of all system elements. In turn, this permits for ease of portability from one car to another. Additionally, the three separate modules (12-volt adapter, alarm, and weight sensor) are connected by cables whose length can be adjusted to fit any car model and back- or front-seat placement of the safety car seat.

### BRIEF DESCRIPTION OF THE FIGURES

The novel features of the invention are set forth in the appended claims. However, for the purpose of explanation, several embodiments of the invention are set forth in the following figures:

FIG. 1—is a general view of an exemplary embodiment in accordance with present disclosure.

FIG. 2—is a circuit schematic of an exemplary embodiment in accordance with present disclosure.

### DETAILED DESCRIPTION OF THE INVENTION

The present invention is a portable security device to be installed in any automobile with a 12-volt power socket. The system includes three modules: a 12-volt adapter 101; an alarm module 102; and a weight sensor 103 as shown in FIG. 1. The alarm module 102 and weight sensor 103 are small enough to be installed under any generally available child safety car seat and permits ease of portability from one car to another. The 12-volt adapter 101 has enough cable length to adjust to any car model and back- or front-seat placement of the safety car seat.

FIG. 2 shows an embodiment of the circuit underlying the invention. The circuit includes a 12-volt rechargeable battery 204 which can be with created with a 9V battery and two AA batteries. All batteries are rechargeable and will recharge while the alarm module 102 remains connected to the vehicle's 12-volt source through the 12-volt adapter 101.

The positive pole of the 12-volt rechargeable battery 204 is connected to the relay common contact 205. In turn, the normally closed relay common contact 205 is connected to the positive contact of the alarm module 202. The negative contact of the alarm module 202 is connected to one contact of the weight sensor 203. The weight sensor 203 will remain open when a child is NOT seated on the safety car seat.

The weight sensor 203 will remain closed, and the alarm module 202 activated with current from the 12-volt rechargeable battery 204, under the following conditions: a) child seated on the safety car seat; and b) vehicle ignition OFF.

After the vehicle's ignition is turn to the ON position, the relay 206 is energized and the position of the relay common contact 205 changes. This change deactivates the alarm module 202 and allows for recharging of the 12-volt rechargeable battery 204.

As a safety precaution the circuit includes a rectifying diode 207 that prevents current from the vehicle's 12-volt power source 201 to interact with current from the 12-volt rechargeable battery 204.

The simplicity of the electronic design allows for a small and lightweight construction of all system elements. This permits for ease of portability from one car to another.

While the invention has been described in connection with preferred embodiments, the description is not intended to limit the invention to those embodiments. On the contrary, it is intended to cover all alternatives, modifications and equivalents that may be included in the spirit and scope of the invention as defined by the appended claims.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

1. A portable security device for notifying when a child is left unattended in a child safety car seat after a vehicle's ignition has been turned off comprising:
an alarm module;
a weight sensor;
a 12-volt adapter;
a 12-volt rechargeable battery;
a relay;
a relay common contact; and
a rectifying diode;
wherein
said 12-volt adapter is meant to be connected to a 12-volt socket and said
weight sensor is meant to be placed under said safety car seat.

2. The portable security device according to claim 1, wherein said weight sensor has a switch that will remain closed when a child is seated in said safety car seat and remain open when the child's weight is no longer on said safety car seat.

3. The portable security device according to claim 1, wherein said 12-volt adapter connects the portable security device to a car's electrical system through said 12-volt socket in order to determine if said vehicle's ignition is turned off or on.

4. The portable security device according to claim 1, wherein said rectifying diode prevents current from said 12-volt socket to interact with current from said 12-volt battery.

5. The portable security device according to claim 1, wherein said relay common contact is opened when said relay is energized with current from said 12-volt socket.

6. The portable security device according to claim 1, wherein said alarm module comprises a speaker that produces sound when said alarm module is activated.

7. The portable security device according to claims 2, 3, 4, 5 and 6, wherein said alarm module is activated if said weigh sensor detects a child seated in said safety car seat and said 12-volt adapter determines that said vehicle's ignition is turned off.

8. The portable security device according to claims 2, 3, 4, 5 and 6, wherein said alarm module is NOT activated if said weigh sensor detects a child seated in said safety car seat and said 12-volt adapter determines that said vehicle's ignition is turned on.
